(19) United States
(12) Patent Application Publication
(10) Pub. No.: US 2012/0127987 A1
(43) Pub. Date: May 24, 2012

(54) PACKET ROUTE MANAGEMENT DEVICE, VoIP SYSTEM AND METHOD OF CONTROLLING VoIP VOICE CALL QUALITY

(75) Inventors: Woon-Seob SO, Daejeon-si (KR); Do-Young KIM, Daejeon-si (KR); Byung-Sun LEE, Daejeon-si (KR)

(73) Assignee: Electronics and Telecommunications Research Institute, Daejeon-si (KR)

(21) Appl. No.: 13/299,794

(22) Filed: Nov. 18, 2011

(30) Foreign Application Priority Data
Nov. 24, 2010 (KR) 10-2010-0117407

(51) Int. Cl. H04L 12/66

(52) U.S. Cl. 370/352

(57) ABSTRACT

A packet route management device, a voice over Internet protocol (VoIP) system, and a method of controlling voice call quality. The packet route management device may manage a packet route in an effort to control VoIP voice call based on bandwidth information of packet route devices. Accordingly, the packet route devices may be allowed to process VoIP packets in real time, and thus voice quality can be maintained at a constant level without packet delay or packet loss.

### CROSS-REFERENCE TO RELATED APPLICATION(S)

This application claims the benefit under 35 U.S.C. §119(a) of Korean Patent Application No. 10-2010-0117407, filed on Nov. 24, 2010, in the Korean Intellectual Property Office, the entire disclosure of which is incorporated herein by reference for all purposes.

### BACKGROUND

1. Field

The following description relates to a voice over Internet protocol (VoIP) technology, and more particularly, to a technology for managing a voice packet route in the Internet network.

2. Description of the Related Art

In an effort to control voice call quality in a voice over Internet protocol (VoIP) system, wired networks use methods defined by IEEE802.p and IEEE802.q and wireless networks use method defined by IEEE802.11e. In addition, an integrated service (IntServe) technique or a differentiated service (DiffServe) technique is used in an upper layer so as to ensure packet transmission quality in an Internet network. The differentiated service technique prioritizes a VoIP voice packet used for transmission so that the VoIP voice packet can be processed earlier than the other types of packets.

However, in actual VoIP communications, voice call connection failure or voice call disconnection happens even when the voice call is established. Such problems occur due to an increase in packet delay or the occurrence of packet loss that is caused when a device on a packet route is not able to process incoming packets in real time because an amount of incoming packets is more than a bandwidth capacity that the device is capable of processing.

### SUMMARY

In one general aspect, there is provided a packet route management device including: a route management unit configured to manage a packet route for controlling voice over Internet protocol (VoIP) voice call quality based on bandwidth information of a packet route device located on a route through which a voice packet is transmitted in the Internet network.

In another general aspect, there is provided a voice over Internet protocol (VoIP) communication system including: an Internet terminal configured to communicate with another terminal over an Internet network; a packet route device configured to be located on a route through which a voice packet of the Internet terminal is transmitted and transmit bandwidth information of the packet route device itself to a packet route management device; and the packet is route management device configured to determine availability of bandwidth of the packet route device based on the transmitted bandwidth information, and to establish a packet route to transmit a voice packet to the other terminal according to the determination result.

In another general aspect, there is provided a method of controlling voice over Internet protocol (VoIP) voice call quality, including: collecting address information and bandwidth information of a packet route device on a route through which a voice packet is transmitted in an Internet network; and determining availability of bandwidth of the packet route device based on the collected address information and bandwidth information, and establishing a packet route to transmit a voice packet in an effort to control quality of VoIP voice call according to the determination result.

Other features and aspects may be apparent from the following detailed description, the drawings, and the claims.

### BRIEF DESCRIPTION OF THE DRAWINGS

FIG. 1 is a diagram illustrating an example of a route of a voice over Internet protocol (VoIP) voice packet.

FIG. 2 is a diagram illustrating an example of a packet route management device.

FIG. 3 is a diagram illustrating an example of voice communication process using a packet route management device and a packet route device.

FIG. 4 is a diagram illustrating an example of a configuration of a database of a packet route management device.

FIGS. 5A to 5C are diagrams illustrating an example of a configuration of a database of a packet route device.

FIG. 6 is a flowchart illustrating an example of procedures of a packet route management is device to manage a packet route device and ensure VoIP voice call quality.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

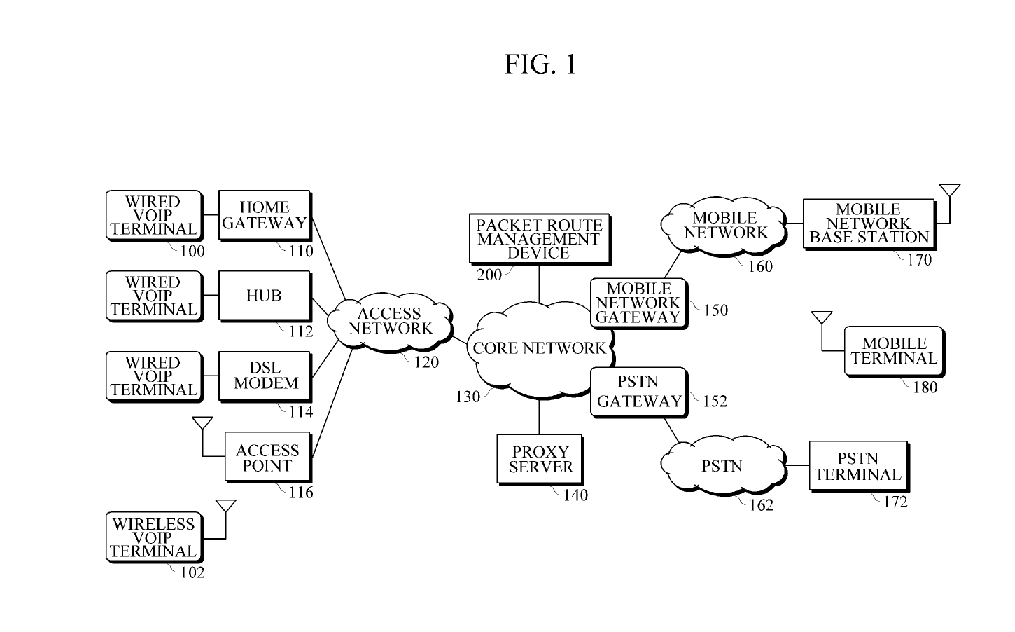

FIG. 1 illustrates a diagram of an example of a route of a voice over Internet protocol (VoIP) voice packet.

Referring to FIG. 1, a wired VoIP terminal 100 which is used at the office by an Internet phone subscriber may access a core Internet network 130 via a hub 112 and an access network 120. The wired VoIP terminal 100 which is used at home may access the core Internet network 130 via a home gateway 110 and the access network 120. A wireless VoIP terminal 102 used by the Internet phone subscriber may access the core Internet network 130 via an access point (AP) 116 and the access network 120.

If a correspondent terminal to which a voice call is made is a public switched telephone network (PSTN) terminal 172, the wired or wireless VoIP terminal 100 or 102 may be connected to a PSTN network 162 via the core Internet network 130 and a PSTN gateway 152. If a correspondent terminal is a mobile terminal 180, the wired or wireless VoIP terminal 100 or 102 is may be connected to a mobile network 160 via the core Internet network 130 and a mobile network gateway 150.

Since the PSTN terminal 172 using the PSTN network 162 only uses a channel allocated per subscriber, a phone call with voice quality ensured can be made without changes in bandwidth. Because the mobile terminal 180 using the mobile network 160 only uses a bandwidth allocated per subscriber, voice call quality can be maintained constant in the mobile network 160 once the call is made.

However, because in the current Internet network connection area a route is established according to a destination address of a packet which is transmitted through the route, congestion may occur when a large amount of packets are transmitted through a particular route. In addition, packet delay and packet loss may occur and degrade voice call quality or cause a voice call to be disconnected. Thus, stable transmission of voice packets in an Internet network connection area by managing and controlling devices on a route of the voice packets is suggested.

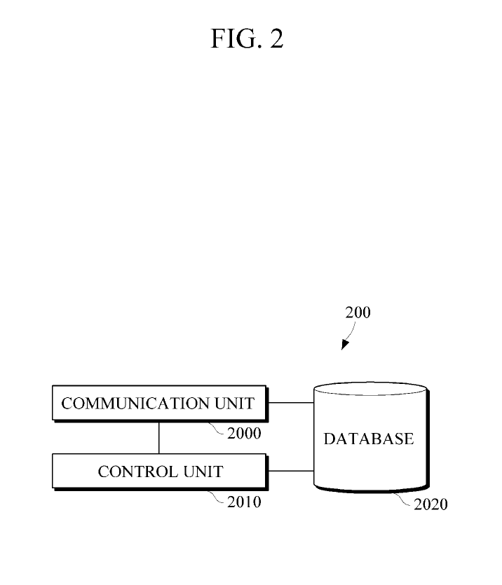

FIG. 2 illustrates a diagram of an example of a packet route management device.

Referring to FIG. 2, the packet route management device 200 may include a communication unit 2000, a control unit 2010, and a database 2020.

The communication unit 2000 may collect address information and bandwidth information of packet route devices on a route through which a VoIP voice packet is transferred. The packet route devices are located on a voice packet transmission route in an access network or a core network. There may be a plurality of packet route devices. The bandwidth information may include maximum available bandwidth, currently available bandwidth and additional available bandwidth. The communication unit 2000 may request the packet route device to transmit bandwidth information at predefined intervals and may periodically receive the bandwidth information.

The control unit 2010 may determine the availability of bandwidth of the packet route device using the address information and bandwidth information of the packet route device collected by the communication unit 2000, and may establish a packet route to transmit a voice packet according to the determination result.

In one example, the control unit 2010 may determine the availability of bandwidth of the packet route device when a voice call is attempted between terminals over the Internet network. If it is determined that an available bandwidth is present, the control unit 2010 may allocate a voice packet to a corresponding packet route device such that the available bandwidth can be used for voice packet transmission, and may receive information about remaining bandwidths. By contrast, if there is no available bandwidth, voice packet transmission to a corresponding packet route device is blocked. In this case, the control unit 2010 may allocate a voice packet to a packet route device that has the largest available bandwidth compared with other packet route devices, and control the packet route device to transmit the voice packet.

In one example, the control unit 2010 may manage the packet route device to have a bandwidth wide enough to accommodate the maximum number of subscribers. Moreover, the control unit 2010 may expand the bandwidth of the packet route device or change to a new packet route device for voice packet transmission if there are subscribers more than the maximum number.

The control unit 2010 may monitor a bandwidth of the packet route device. If a monitoring result shows that there is no available bandwidth and thus there is no new route available, the control unit 2010 may generate an alarm message to inform of the result.

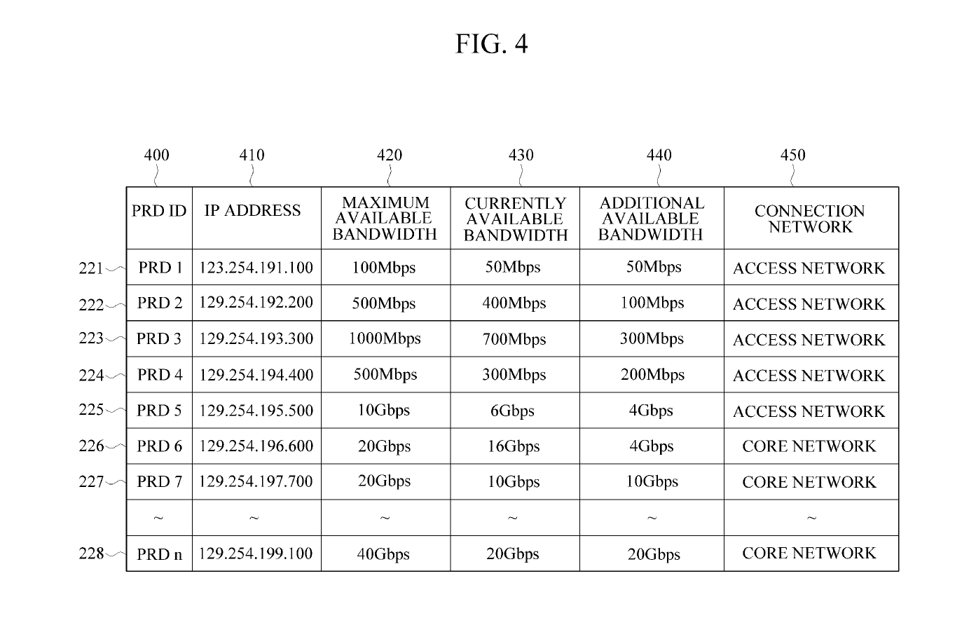

The database 2020 may store address information and bandwidth information of a packet device. The structure of the database 2020 will be described with reference to FIG. 4.

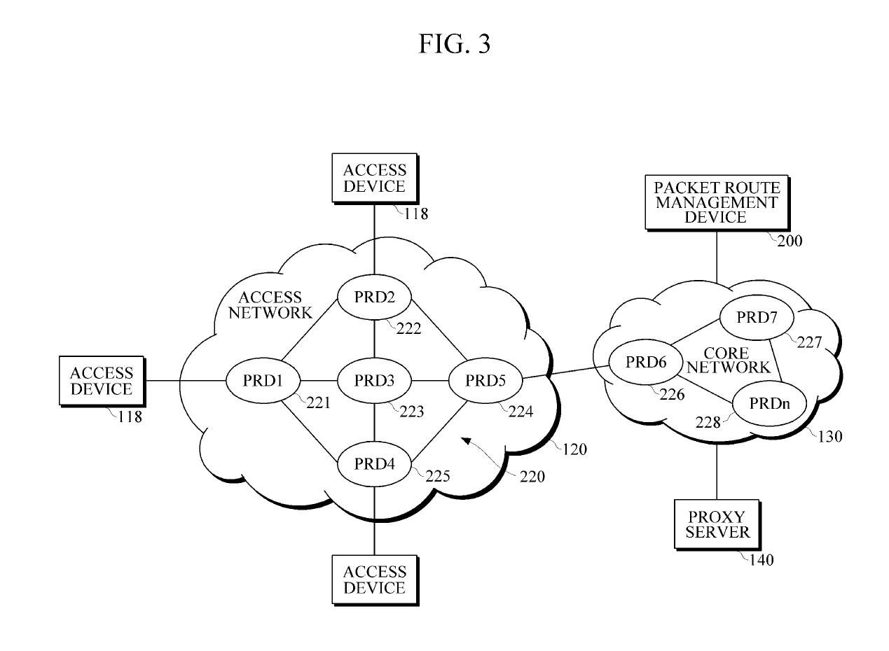

FIG. 3 illustrates a diagram of an example of voice communication process using a is packet route management device and a packet route device.

Referring to FIG. 3, the packet route device (PRD) 220 may be located in an Internet network. For example, as shown in FIG. 3, PRD1 221, PRD2 222, PRD3 223, PRD4 224, and PRD5 225 are located in an access network 120, and PRD6 226, PRD7 227 and PRDn 228 may be located in a core network 130. The packet route device 220 may be located on a route through which a VoIP voice packet is transmitted in the Internet network.

The packet route management device 220 may communicate with the packet route device 220 and receive bandwidth information of the packet route device 220. When an Internet subscriber terminal is connected to a network and subscriber registration process is performed, device information of the packet route device 220 in the access network 120 which the subscriber terminal accesses is reported to the packet route management device 200. In response to an attempt to of the subscriber terminal to make a phone call, an Internet protocol (IP) address of a correspondent terminal is reported to the packet route management device 200 using a response message of a proxy server 140. If the correspondent terminal is an Internet subscriber terminal, an IP address of the packet route device 220 in the access network 120 to which the subscriber terminal is connected is reported to the packet route management device 200.

An access device 118 may be one of the home gateway 110, the hub 112, a DSL modem 114 and an access point 116 which are shown in the example illustrated in FIG. 1.

In response to an attempt to make an Internet phone call between the Internet subscriber terminals, the packet route management device 200 may collect and manage IP address information of the packet route device 220 that accesses the Internet network. Accordingly, the packet route management device 200 is able to identify an address of the packet route device 220 on the voice packet transmission route and recognize bandwidth information of the packet route device 220 through communication. In addition, the packet route management device 200 may collect the bandwidth information to build and manage a database.

In one example, before a phone call is established between the terminals, the packet route management device 200 may check current bandwidth information of the packet route device 220 to be used. Then, when a new call is attempted, the packet route management device 200 may determine whether or not the packet route device 220 has a sufficient bandwidth.

If it is determined that the packet route device 220 has a sufficient bandwidth, the packet route management device 200 may allocate a predefined bandwidth to the packet route device 200. In response, the packet route device 220 may transmit a voice packet using a predefined bandwidth from the allocated bandwidth. Information about a bandwidth remaining from the allocated bandwidth after use for the voice packet transmission may be reported to the packet route management device 200.

If it is determined that the packet route device 220 does not have a sufficient bandwidth, the packet route management device 200 may block the voice packet transmission to the packet route device 220. Furthermore, the packet management device 200 may calculate a bandwidth of the packet route device 220 and allocate a new packet during a phone call only when it is determined that the packet route device 220 has a sufficient bandwidth. The packet route device 220 that has an insufficient bandwidth may be blocked from the voice packet transmission.

As described above, if the voice packet is transmitted using the bandwidth information of the packet route device 220, a predefined bandwidth is ensured with respect to the packet route device 220 that transmits the voice packet during the call, and thus congestion may be prevented. As a result, VoIP voice call quality can be maintained constant.

In a case where the packet route device 220 in access to the access network 120 does not have an insufficient bandwidth when a VoIP terminal subscriber attempts to make a new voice call, a call connection may not be made. In one example, the packet route management device 200 may monitor a bandwidth of the packet route device 220 and inform of a situation in which the packet route device 220 does not have a bandwidth enough to provide a new route before a connection error occurs. In response to the information, an administrator may take a proper action.

In one example, the packet route management device 200 may mange the packet route device 220 to have a bandwidth wide enough to accommodate the maximum number of subscribers. In this case, if there are more than the maximum number of subscribers, the packet route management device 200 may expand a bandwidth of the packet route device 220 or may control a voice packet to be transmitted through a new packet route device. Accordingly, voice packet traffic can be distributed.

A number of packet route devices are located in the core network 130. Hence, the packet route management device 200 may manage the packet route device 220 to transmit a voice packet through a new route. If VoIP voice call connection is not established or quality of VoIP voice call is degraded even without a specific problem of bandwidth of the packet route device 220, a physical condition of the packet route device 220 on the VoIP call route may be examined and appropriate action may be taken.

During a voice call between the VoIP terminal and a PSTN phone terminal, in a region from the PSTN gateway to the PSTN terminal, a call bandwidth is allocated per terminal, and thus voice call quality degradation does not occur. Hence, a bandwidth of voice packet route with respect to an Internet network between the VoIP terminal and the PSTN gateway can be ensured. Accordingly, quality of overall voice call can be secured.

During a voice call between the VoIP terminal and the mobile terminal, in a region from is a mobile network gateway to the mobile terminal, a call bandwidth is allocated per the terminal, and thus voice call quality degradation does not occur. Hence, a bandwidth of a voice packet route with respect to an Internet network between the VoIP terminal and the mobile gateway is ensured. As a result, quality of overall voice call can be secured.

FIG. 4 illustrates a diagram of an example of a configuration of a database of a packet route management device.

Referring to FIG. 4, the packet route management device may include information about each of a plurality of packet route devices used for a voice call packet route, including a device identifier 400, an IP address 410, a maximum available bandwidth 420, a currently used bandwidth 430, an additional available bandwidth 440, and information of a connected network 450. In the example shown in FIG. 4, like the example shown in FIG. 3, it is assumed that PRD1 221, PRD2 222, PRD3 223, PRD4 224 and PRD5 225 are located in an access network and PRD6 226, PRD7 227, and PRDn 228 are located in a core network.

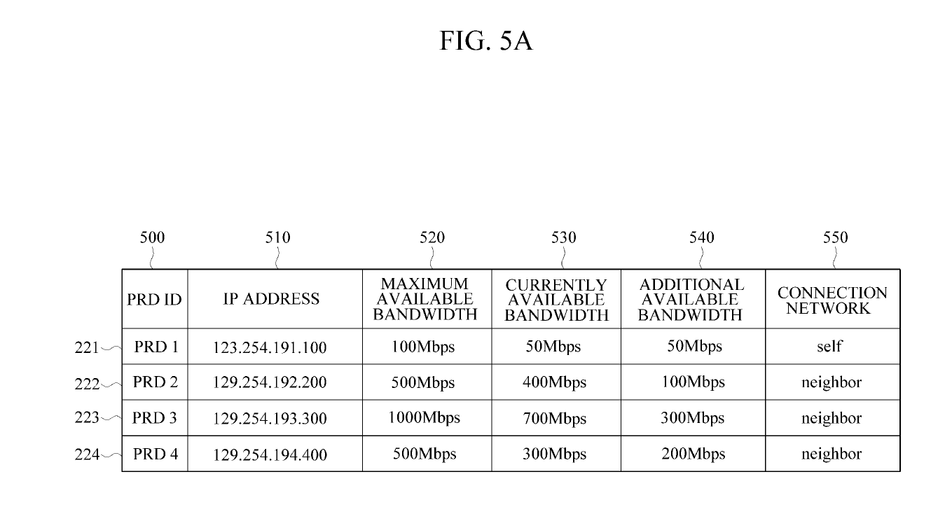

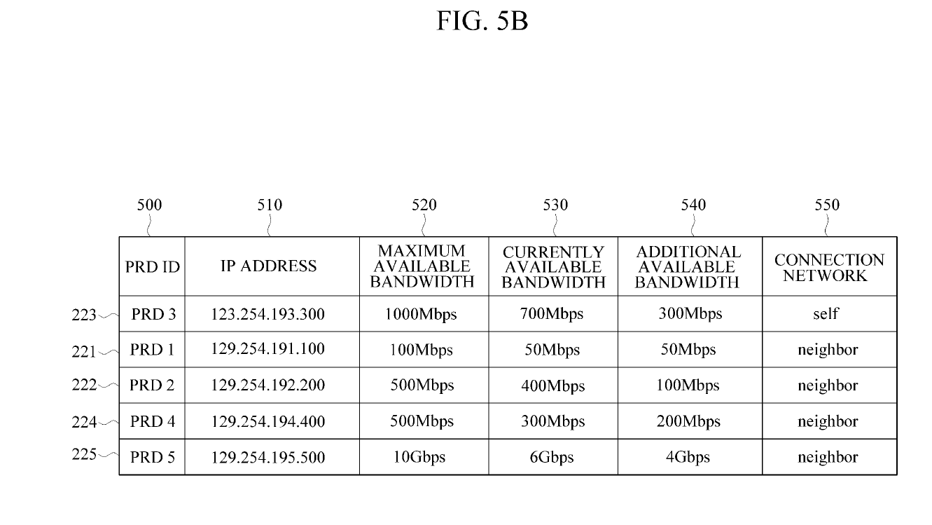

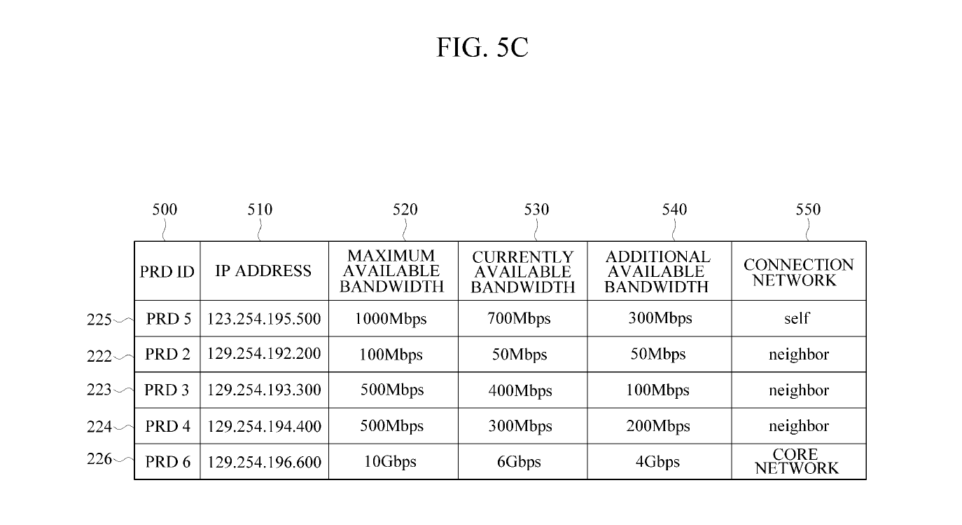

FIGS. 5A to 5C illustrate diagrams of an example of a configuration of a database of a packet route device.

Referring to FIGS. 5A to 5C, the database of the packet route device may include information about the packet route device itself and neighboring packet route devices, including a device identifier 500, an IP address 510, a maximum available bandwidth 520, a currently used bandwidth 530, an additional available bandwidth 540, and information of a connected network 550.

In the examples shown in FIGS. 5A to 5C, it is assumed that PRD1 221, PRD2 222, PRD3 223, PRD4 224, and PRD5 225 are located in an access network and PRD6 226, PRD7 227, and PRDn 228 are located in a core network, like an example shown in FIG. 3. Also, it is assumed that the connection structure between PRD1 221, PRD2 222, PRD3 223, PRD4 224, and PRD5 225 is the same as the example shown in FIG. 3.

Referring to FIG. 5A, with respect to RRD1 221, bandwidth information of neighboring PRDs, PRD2 222 and PRD3 223, may be identified. It is also identified that PRD3 223 has the largest maximum available bandwidth, the largest currently used bandwidth, and the largest additional available bandwidth. Therefore, the packet route management device 200 may establish a packet route as PRD1 221-PRD3 223.

Referring to FIG. 5B, with respect to PRD3 223, bandwidth information of neighboring PRDs, which are PRD1 221, PRD222, PRD4 221, and PRD5 225, may be identified. Among the neighboring PRDs, PRD5 225 has the largest maximum available bandwidth, the largest currently used bandwidth, and the largest additional available bandwidth. Thus, the packet route management device 200 may establish a packet route as PRD1 221-PRD3 223-PRD5 225.

Referring to FIG. 5C, with respect to PRD5 225, bandwidth information of neighboring PRDs, which are PRD2 222, PRD3 223, PRD4 224, and PRD6 226, may be identified. Among these neighboring PRDs, PRD6 226 has the largest maximum available bandwidth, the largest currently used bandwidth, and the largest additional available bandwidth. Thus, the packet route management device 200 may establish a packet route as PRD1 221-PRD3 223-PRD5 225-PRD6 226.

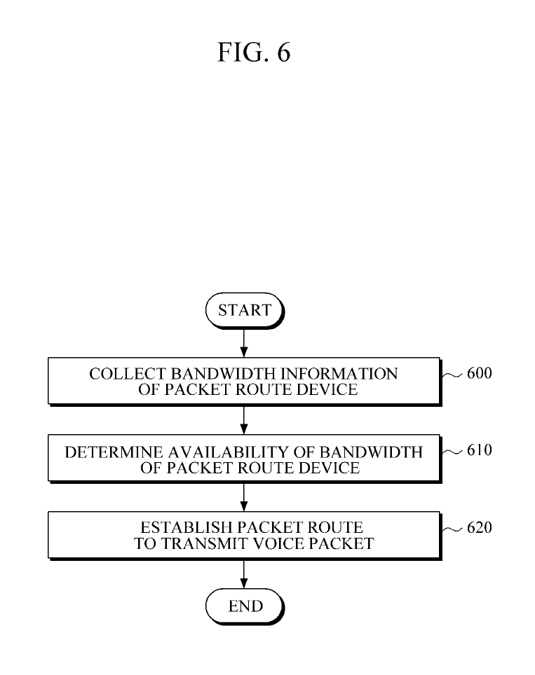

FIG. 6 illustrates a flowchart of an example of procedures of a packet route management device to manage a packet route device and ensure VoIP voice call quality.

Referring to FIG. 6, the packet route management device 200 (see FIG. 3) collects address information and bandwidth information of the packet route device 220 located on a route through which a voice packet is transmitted in an Internet network in operation 600. The bandwidth information includes a maximum available bandwidth, a currently available bandwidth, and an additional available bandwidth.

Thereafter, in operation 610, it is determined the availability of a bandwidth of the packet route device 220 based on the collected address information and bandwidth information. According to the determination result, a packet route is established to transmit a voice packet in operation 620.

In operation 620, if there is an available bandwidth, the packet route management device 200 may allocate a voice packet to a corresponding packet route device, allowing the packet route device to use the available bandwidth for the transmission of the voice packet, and may receive information about the remaining bandwidth. In this case, among a plurality of the packet route devices, a packet route device having the largest available bandwidth may be allocated the voice packet for transmission. If it is determined that there is no available bandwidth, voice packet transmission to a corresponding packet route device may be blocked.

As illustrated in the above examples, in a VoIP voice call through an Internet network, inherent address information of each of voice packet path devices, and the largest and available bandwidth information may be managed. Accordingly, the voice packet path devices are enabled to process a VoIP voice packet in real time, thereby preventing packet delay or packet loss. Furthermore, voice quality of a constant level may be assured.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A packet route management device comprising:
a route management unit configured to manage a packet route for controlling voice over Internet protocol (VoIP) voice call quality based on bandwidth information of a packet route device located on a route through which a voice packet is transmitted in the Internet network.

2. The packet route management device of claim 1, wherein the route management unit is configured to comprise
a communication unit configured to collect address information and the bandwidth information of the packet route device,
a control unit configured to determine availability of bandwidth of the packet route device based on the collected address information and bandwidth information and to establish the packet route to transmit the voice packet according to the determination result and
a database configured to store the address information and bandwidth information of the packet route device.

3. The packet route management device of claim 2, wherein the control unit is further configured to determine the availability of bandwidth of the packet route device when a voice call between terminals is attempted over the Internet network, and, if there is an available bandwidth, allocate a voice packet to the packet route device to use the available bandwidth for voice packet transmission, or if there is no available bandwidth, block voice packet transmission to the packet route device.

4. The packet route management device of claim 3, wherein the control unit is further configured to allocate the voice packet to a packet route device having the largest available bandwidth from among a plurality of packet route devices and control the packet route device to transmit the voice packet.

5. The packet route management device of claim 3, wherein the control unit is further configured to, if there is an available bandwidth, receive, from the packet route device, and manage information about a bandwidth that is remaining from the available bandwidth after use for the voice packet transmission.

6. The packet route management device of claim 2, wherein the bandwidth information is at least one of a maximum available bandwidth, a currently available bandwidth, and an additional available bandwidth.

7. The packet route management device of claim 2, wherein the control unit is further configured to manage the packet route device to have a bandwidth wide enough to accommodate the maximum number of subscribers, and if there are more than the maximum number of subscribers, expand the bandwidth of the packet route device or manage a voice packet to be transmitted through a new packet route device.

8. The packet route management device of claim 2, wherein the control unit is further configured to monitor the bandwidth of the packet route device, and to generate an alarm message to inform of a situation in which a new route is not available any longer due to the lack of an available bandwidth of the packet route device.

9. The packet route management device of claim 2, wherein the communication unit is further configured to request the packet route device for the bandwidth information at predefined intervals and receive the bandwidth information periodically.

10. The packet route management device of claim 1, wherein the route management unit is further configured to manage a packet route by targeting a packet route device corresponding to an Internet network between an Internet terminal and a public telephone network gateway when a voice call is made between the Internet terminal and a public telephone terminal and manage a packet route by targeting a packet route device corresponding to an Internet network between an Internet terminal and a mobile network gateway when a voice call is made between the Internet terminal and a mobile terminal.

11. A voice over Internet protocol (VoIP) communication system comprising:
an Internet terminal configured to communicate with another terminal over an Internet network;
a packet route device configured to be located on a route through which a voice packet of the Internet terminal is transmitted and transmit bandwidth information of the packet route device itself to a packet route management device; and
the packet route management device configured to determine availability of bandwidth of the packet route device based on the transmitted bandwidth information, and to establish a packet route to transmit a voice packet to the other terminal according to the determination result.

12. The VoIP communication system of claim 11, wherein the bandwidth information is at least one of a maximum available bandwidth, a currently available bandwidth, and an additional available bandwidth.

13. A method of controlling voice over Internet protocol (VoIP) voice call quality, comprising:
collecting address information and bandwidth information of a packet route device on a route through which a voice packet is transmitted in an Internet network; and
determining availability of bandwidth of the packet route device based on the collected address information and bandwidth information, and establishing a packet route to transmit a voice packet in an effort to control quality of VoIP voice call according to the determination result.

14. The method of claim 13, wherein the determining of the availability and the establishing of the packet route comprise
determining the availability of bandwidth of the packet route device when a voice call between terminals over the Internet network is attempted,
if there is an available bandwidth, allocating a voice packet to the packet route device so as to use the available bandwidth for voice packet transmission, and
if there is no available bandwidth, blocking voice packet transmission to the packet route device.

15. The method of claim 14, wherein the allocating of the voice packet to use the valid bandwidth for voice packet transmission comprises allocating the voice packet to a packet route device having the largest available bandwidth among a plurality of packet route devices.

16. The method of claim 13, wherein the bandwidth information is at least one of a maximum available bandwidth, a currently available bandwidth, and an additional available bandwidth.
